(19) United States
(12) Patent Application Publication
(10) Pub. No.: US 2026/0049913 A1
(43) Pub. Date: Feb. 19, 2026

(54) TEST APPARATUS, DISPLAY CONTROL METHOD, AND STORAGE MEDIUM

(71) Applicant: SHIMADZU CORPORATION, Kyoto-shi (JP)

(72) Inventor: Tohru MATSUURA, Kyoto-shi (JP)

(21) Appl. No.: 19/303,207

(22) Filed: Aug. 18, 2025

(30) Foreign Application Priority Data
Aug. 19, 2024 (JP) 2024-137774

(51) Int. Cl. G01N 3/06; G01N 3/08

(52) U.S. Cl. CPC G01N 3/068; G01N 3/08

(57) ABSTRACT

A test apparatus includes a display controller. The display controller displays a load measurement value image indicating a measured value of a load measured by a load measurement unit at a predetermined measurement time point, a load measurement graph image showing a time-series transition of the load measured by the load measurement unit during a predetermined measurement period including the predetermined measurement time point, and a load measurement label image, in a first area of a test monitor screen. The display controller also displays a change measurement value image indicating a measured value of a change measured by a change measurement unit at the predetermined measurement time point, a change measurement graph image showing a time-series transition of the change measured by the change measurement unit during the predetermined measurement period, and a change measurement label image, in a second area different from the first area.

### INCORPORATION BY REFERENCE

The present application claims priority under 35 U.S.C. § 119 to Japanese Patent Application No. 2024-137774 filed on Aug. 19, 2024. The content of the application is incorporated herein by reference in its entirety.

### TECHNICAL FIELD

The present invention relates to a test apparatus, a display control method, and a storage medium.

### BACKGROUND ART

A material testing machine, which is a type of test apparatus, includes a load mechanism that applies a test force to a test piece, a force detector that detects the force actually applied to the test piece, a displacement detector that detects the displacement of the test piece, and a display device that displays the measured values from the force detector and the displacement detector (see, for example, Patent Document 1).

As a display mode for measured values by the display device, one is known that displays, on a single display, the current (at the time of measurement) measured value and a bar graph indicating the degree of displacement of the measured value from a zero point (Display Example 1). Also known is one that displays the transition of measured values of test force and displacement superimposed for one cycle on a common time axis in a time series on a single display (Display Example 2).

### PRIOR ART DOCUMENT

### Patent Document

### [Patent Document 1]

Japanese Unexamined Patent Application Publication No. 2019-52997

### SUMMARY OF INVENTION

### Problem to be Solved by the Invention

In the conventional Display Example 1 described above, since only the current measured value is displayed on the screen, the time-series transition of the measured value cannot be grasped, and in order to grasp the time-series transition of the measured value, an operation to switch to a separate screen of Display Example 2 is necessary, which is inconvenient. Furthermore, in Display Example 2, since the time-series transition graph of the test force and the transition graph of the displacement are displayed superimposed on a common time axis, it is difficult to distinguish which of the two transition graphs indicates the test force and which indicates the displacement, which is inconvenient.

The present invention has been made in view of such a background, and an object thereof is to provide a test apparatus, a display control method, and a storage medium that can display the measurement history of the load applied to a test piece and the change in the test piece according to the load in a manner that is easily understandable.

### Means for Solving the Problem

A first aspect of the present invention relates to a test apparatus comprising: a test load applying unit that applies a test load to a test piece; a load measurement unit that measures a load acting on the test piece; a change measurement unit that measures a change occurring in the test piece; a controller that controls an operation of the test load applying unit; a display unit; and a display controller that causes the display unit to display a test monitor screen including a load monitor image that displays a measurement history of the load by the load measurement unit and a change monitor image that shows a measurement history of the change by the change measurement unit, wherein the display controller displays, as the load monitor image, a load measurement value image indicating a measured value of the load measured by the load measurement unit at a predetermined measurement time point, a load measurement graph image showing a time-series transition of the load measured by the load measurement unit during a predetermined measurement period including the predetermined measurement time point, and a load measurement label image indicating that it is a measurement result of the load, in a first area of the test monitor screen, and displays, as the change monitor image, a change measurement value image indicating a measured value of the change measured by the change measurement unit at the predetermined measurement time point, a change measurement graph image showing a time-series transition of the change measured by the change measurement unit during the predetermined measurement period, and a change measurement label image indicating that it is a measurement result of the change, in a second area of the test monitor screen different from the first area.

A second aspect of the present invention relates to a display control method executed by a computer when a predetermined test is being performed in a test apparatus having a test load applying unit that applies a test load to a test piece and a test execution unit that controls an operation of the test load applying unit to execute the predetermined test, the method comprising: a load measurement step of measuring a load acting on the test piece; a change measurement step of measuring a change occurring in the test piece; and a display control step of causing a display unit to display a test monitor screen including a load monitor image that displays a measurement history of the load by the load measurement step and a change monitor image that shows a measurement history of the change by the change measurement step, wherein the display control step displays, as the load monitor image, a load measurement value image indicating a measured value of the load measured by the load measurement step at a predetermined measurement time point, a load measurement graph image showing a time-series transition of the load measured by the load measurement step during a predetermined measurement period including the predetermined measurement time point, and a load measurement label image indicating that it is a measurement result of the load, in a first area of the test monitor screen, and displays, as the change monitor image, a change measurement value image indicating a measured value of the change measured by the change measurement step at the predetermined measurement time point, a change measurement graph image showing a time-series transition of the change measured by the change measurement step during the predetermined measurement period, and a change label image indicating that it is a measurement result of the change, in a second area of the test monitor screen different from the first area.

A third aspect of the present invention relates to a non-transitory computer readable storage medium storing a program that, when a predetermined test is being performed in a test apparatus having a test load applying unit that applies a test load to a test piece and a test execution unit that controls an operation of the test load applying unit to execute the predetermined test, causes a computer to function as: a load measurement unit that measures a load acting on the test piece; a change measurement unit that measures a change occurring in the test piece; and a display controller that causes a display unit to display a test monitor screen including a load monitor image that displays a measurement history of the load by the load measurement unit and a change monitor image that shows a measurement history of the change by the change measurement unit, wherein the display controller displays, as the load monitor image, a load measurement value image indicating a measured value of the load measured by the load measurement unit at a predetermined measurement time point, a load measurement graph image showing a time-series transition of the load measured by the load measurement unit during a predetermined measurement period including the predetermined measurement time point, and a load measurement label image indicating that it is a measurement result of the load, in a first area of the test monitor screen, and displays, as the change monitor image, a change measurement value image indicating a measured value of the change measured by the change measurement unit at the predetermined measurement time point, a change measurement graph image showing a time-series transition of the change measured by the change measurement unit during the predetermined measurement period, and a change label image indicating that it is a measurement result of the change, in a second area of the test monitor screen different from the first area.

### Effects of the Invention

According to the test apparatus, the display control method, and the storage medium of the present invention, when a predetermined test for applying a test load to a test piece is being performed, a test monitor screen is displayed on the display unit, the screen including a load monitor image showing the measurement result of the load applied to the test piece and a change monitor image showing the measurement result of the change occurring in the test piece. Then, as the load monitor image, a load measurement label image that clearly indicates that the display object is the load, a load measurement value image, and a load measurement graph are displayed in a first area, and as the change monitor image, a change measurement label image that clearly indicates that the display object is the change in the test piece, a change measurement value image, and a change measurement graph are displayed in a second area.

This makes it possible to display the measurement history of the load applied to the test piece and the change in the test piece according to the load, including the current value and the status of the time-series transition, on a single display in a manner that is easily visible to the user.

### BRIEF DESCRIPTION OF THE DRAWINGS

FIG. 1 is a diagram schematically showing a configuration of a test apparatus according to an embodiment.

FIG. 2 is a diagram showing a functional configuration of a control device and a processing device.

FIG. 3 is a flowchart showing a procedure of a display process for a test monitor screen during a material test.

FIG. 4 is a diagram showing a first display example of the test monitor screen.

FIG. 5 is a diagram showing a second display example of the test monitor screen.

FIG. 6 is a diagram showing a third display example of the test monitor screen.

### DESCRIPTION OF EMBODIMENTS

Hereinafter, an embodiment of the present invention will be described with reference to the drawings. In this embodiment, a high-speed tensile testing machine will be described as a test apparatus according to the present invention.

### 1. Configuration of High-Speed Tensile Testing Machine

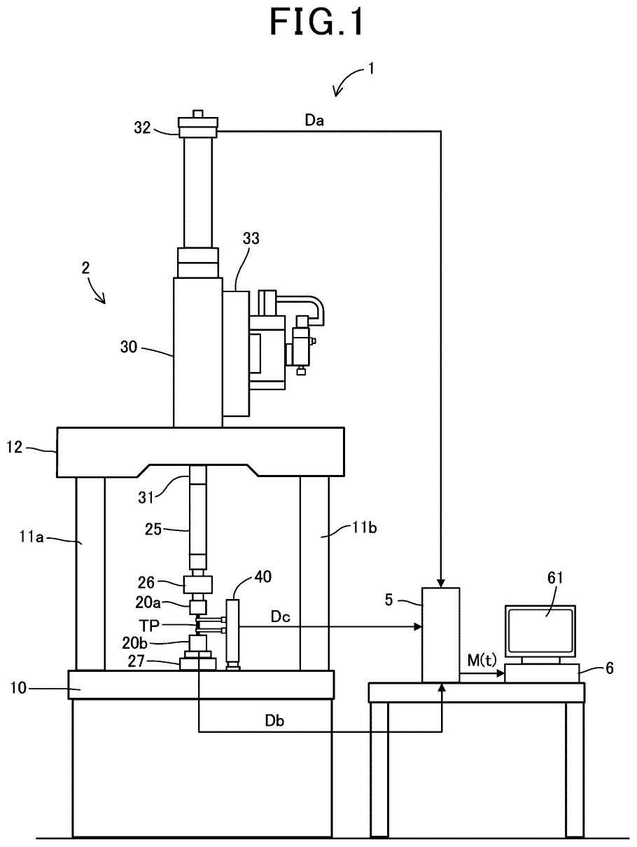

FIG. 1 is a diagram schematically showing a configuration of a high-speed tensile testing machine 1 according to the present embodiment.

The high-speed tensile testing machine 1 performs a high-speed tensile test by applying a tensile force (test load) to a test piece TP of a material, which is a test object, at a predetermined impact speed. The high-speed tensile testing machine 1 includes a testing machine main body 2, a control device 5, and a processing device 6. The test object is various materials, industrial products, or parts or members of industrial products, and the test piece TP is prepared according to a predetermined standard for material testing. The test piece TP is, for example, a resin material of a predetermined composition.

The testing machine main body 2 includes a table 10, a pair of support columns 11a, 11b erected on the table 10, a cross yoke 12 bridged between the pair of support columns 11a, 11b, and a hydraulic cylinder 30 fixed to the cross yoke 12. The hydraulic cylinder 30 constitutes a load mechanism that applies a tensile force to the test piece TP in the testing machine main body 2 and operates by hydraulic oil supplied from a hydraulic source (not shown) arranged in the table 10 via a servo valve 33.

An upper chuck 20a is connected to a piston rod 31 of the hydraulic cylinder 30 via an approach jig 25 and a joint 26. A lower chuck 20b is provided on the table 10 via a load cell 27, which is a force detector. The upper chuck 20a and the lower chuck 20b correspond to a pair of gripping tools of the present disclosure. With such a configuration, the testing machine main body 2 pulls up the piston rod 31 at a predetermined impact speed. As a result, a force that rapidly separates the upper chuck 20a and the lower chuck 20b acts on them, and this force acts as a tensile force on the test piece TP gripped by the upper chuck 20a and the lower chuck 20b. The configuration for applying a tensile force to the test piece TP in this manner corresponds to the test load applying unit of the present disclosure.

The testing machine main body 2 is provided with a stroke sensor 32 that outputs a stroke detection signal Da corresponding to the amount of displacement of the upper chuck 20a (i.e., the movement amount of the piston rod 31) to the control device 5, and a load cell 27, which is a force detector, that outputs a force detection signal Db indicating the tensile force to the control device 5.

Furthermore, an extensometer 40, which is a displacement detector, is attached to the test piece TP. The extensometer 40 has an upper arm and a lower arm that grip the test piece TP and displace together with the test piece TP, and detects the amount of elongation (amount of displacement) of the test piece TP by detecting the displacement of the upper arm and the lower arm with a linear sensor or the like. The extensometer 40 outputs a displacement detection signal Dc indicating the amount of displacement of the test piece TP to the control device 5.

The control device 5 executes a high-speed tensile test by controlling the operation of the testing machine main body 2, and during the execution of the high-speed tensile test, acquires the stroke detection signal Da output from the stroke sensor 32, the force detection signal Db output from the load cell 27, and the displacement detection signal Dc output from the extensometer 40 for each predetermined measurement cycle. A processing device 6 configured by a personal computer or the like is connected to the control device 5 by a wired or wireless connection.

The stroke detection signal Da, the force detection signal Db, and the displacement detection signal Dc acquired by the control device 5 are transmitted from the control device 5 to the processing device 6 at an appropriate timing as time-series measurement data M(t) (where t indicates the measurement time point). The processing device 6 displays a test monitor screen on a display 61, showing the execution status of the high-speed tensile test based on the measurement data M(t). The processing device 6 also functions as an input interface for setting various setting parameters (for example, impact speed) for the high-speed tensile test to the control device 5.

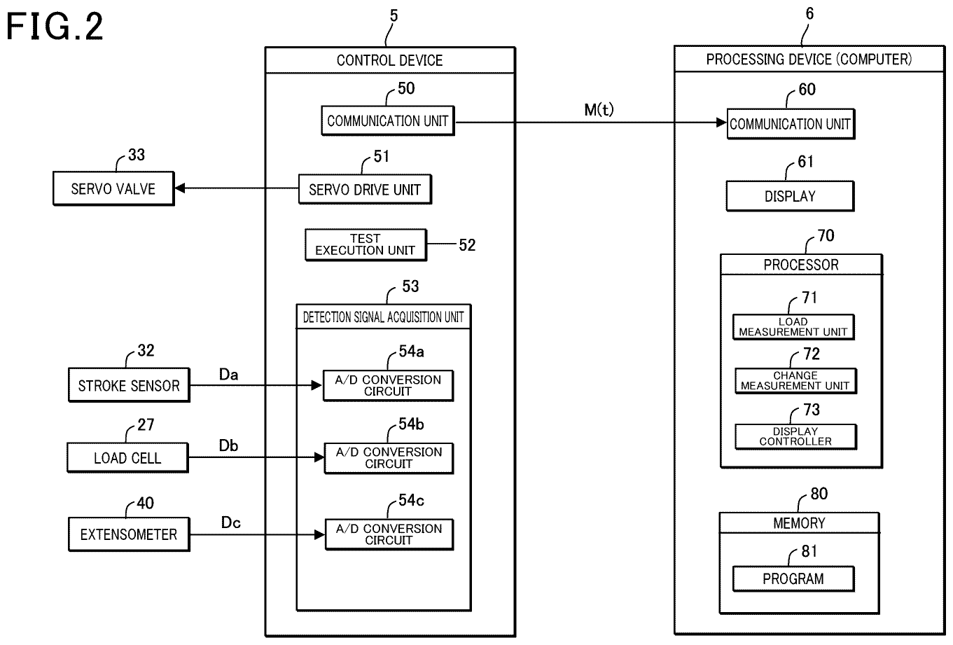

FIG. 2 is a diagram showing a functional configuration of the control device 5 and the processing device 6. The control device 5 includes a communication unit 50 (transmitter/receiver, circuit), a servo drive unit 51, a test execution unit 52, and a detection signal acquisition unit 53. The control device 5 is a computer unit including a processor such as a CPU or MPU, a memory such as ROM or RAM, a storage device such as an HDD or SSD, and an interface circuit for connecting sensors, peripheral devices, and the like. The processor of the control device 5 executes a control program for the control device 5 stored in the memory or storage device, thereby realizing the functions shown in FIG. 2.

The servo drive unit 51 outputs a control signal to the servo valve 33 to operate the hydraulic cylinder 30 so that the piston rod 31 is pulled up at a predetermined speed. The test execution unit 52 executes a high-speed tensile test by controlling the operation of the hydraulic cylinder 30 via the servo drive unit 51. The configuration in which the test execution unit 52 controls the operation of the hydraulic cylinder 30 corresponds to the controller of the present disclosure.

The detection signal acquisition unit 53 includes A/D conversion circuits 54a, 54b, and 54c that sequentially acquire each of the stroke detection signal Da, the force detection signal Db, and the displacement detection signal Dc, perform A/D conversion, and output them. The outputs of the A/D conversion circuits 54a, 54b, and 54c become the measurement data M(t) transmitted from the control device 5 to the processing device 6.

The A/D conversion circuits 54a to 54c operate in synchronization with a common clock signal and synchronously perform the acquisition of the stroke detection signal Da, the force detection signal Db, and the displacement detection signal Dc, and the output of the time-series measurement data M(t) consisting of these digital conversion values, at a predetermined measurement sampling period. An appropriate clock circuit may be used as the generation source of the clock signal, and for example, a clock circuit included in the processor may be used.

The processing device 6 is a computer unit having a communication unit 60 (transmitter/receiver, circuit), a display 61 (corresponding to the display unit of the present disclosure), a processor 70, a memory 80, and the like. A control program 81 for the processing device 6 is stored in the memory 80. The processor 70 reads and executes the program 81, thereby functioning as a load measurement unit 71, a change measurement unit 72, and a display controller 73.

The load measurement unit 71 measures the test force applied to the test piece TP based on the digital conversion value of the force detection signal Db included in the measurement data M(t). The change measurement unit 72 measures the displacement of the test piece TP (corresponding to the change of the test piece of the present disclosure) based on the digital conversion value of the displacement detection signal Dc included in the measurement data M(t). Note that the change measurement unit 72 may measure the displacement of the test piece TP based on the digital conversion value of the stroke detection signal Da included in the measurement data M(t). Also, the displacement of the test piece TP may be measured using a non-contact type extensometer that detects the displacement of the test piece TP from a captured image of the test piece TP by a high-speed video camera.

The processing executed by the load measurement unit 71 corresponds to the load measurement step in the display control method of the present disclosure, and the processing executed by the change measurement unit 72 corresponds to the change measurement step in the display control method of the present disclosure. The processing executed by the display controller 73 corresponds to the display control step in the display control method of the present disclosure.

### 2. Display Control Process for Test Monitor Screen

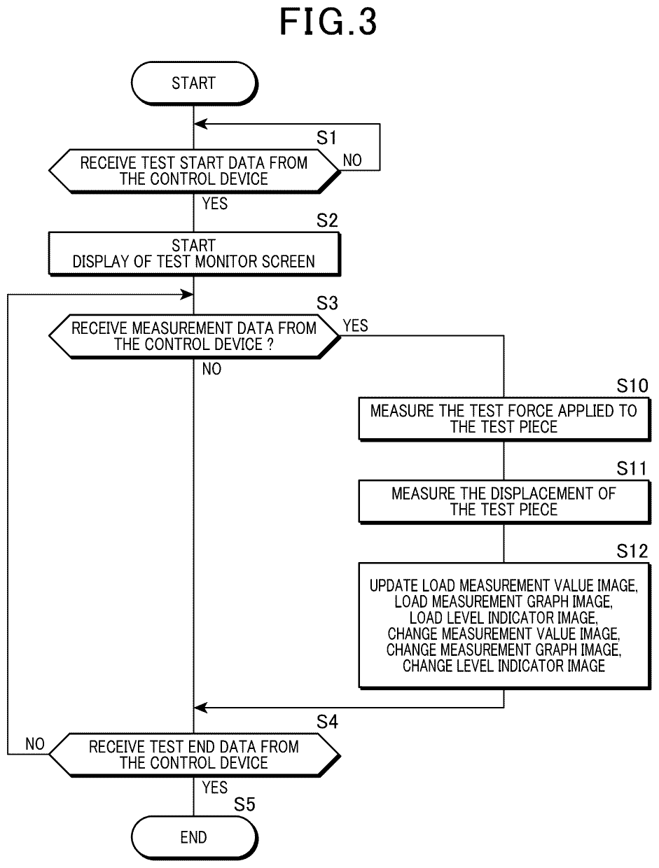

The procedure of the display control process for the test monitor screen displayed on the display 61, which is executed by the processing device 6 when a high-speed tensile test is being performed by the control device 5, will be described with reference to the flowchart shown in FIG. 3. Note that the display control process for the test monitor screen described below is also executed when the control device 5 controls the operation of the hydraulic cylinder 30 to keep the position or load of the hydraulic cylinder 30 constant, or when the control device 5 is not controlling the operation of the hydraulic cylinder 30 (e.g., when the hydraulic source of the hydraulic cylinder 30 is stopped), during a “preparing” or “standby” state, which is not during a general test.

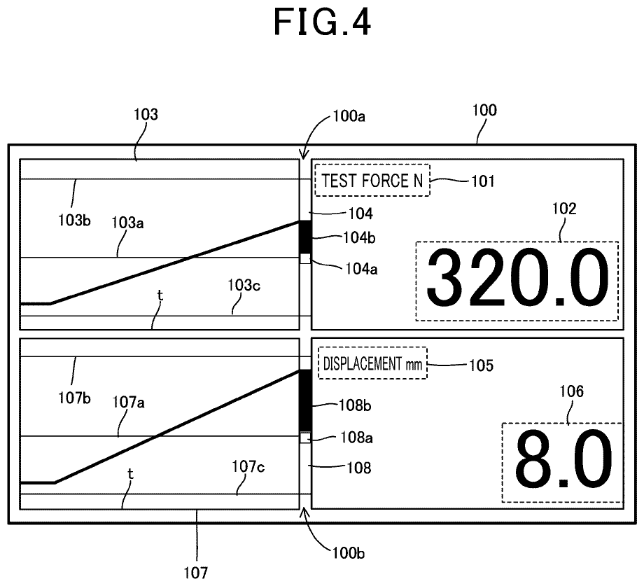

In step S1 of FIG. 3, when the display controller 73 receives test start data indicating that the high-speed tensile test has started from the control device 5, the process proceeds to step S2, and as shown in FIG. 4, the display of the test monitor screen 100 on the display 61 is started. With reference to FIG. 4, the test monitor screen 100 includes a load monitor image 100a displayed in the upper half area of the test monitor screen 100 (corresponding to the first area of the present disclosure) and a change monitor image 100b displayed in the lower half area of the test monitor screen 100 (corresponding to the second area of the present disclosure).

The display controller 73 displays, as the load monitor image 100a, a load measurement label image 101 that clearly indicates that the display object is the measurement history of the test force, a load measurement value image 102 that shows the current (corresponding to the predetermined measurement time point of the present disclosure) measured value of the test force, a load measurement graph image 103 that shows the transition of the test force from the start of the test, and a load level indicator image 104 that shows the measurement level of the test force. In the load monitor image 100a, the load measurement value image 102, the load measurement graph image 103, and the load measurement label image 101 are displayed in the upper half area (first area) of the test monitor screen 100 in a positional relationship where their respective correspondences can be recognized.

The load measurement graph image 103 shows the transition of the test force from the start of the test, with the vertical axis set to the level of the test force and the horizontal axis set to time t, and shows a reference point (zero point) 103a of the test force, a positive-side limit 103b of the test force, and a negative-side limit 103c of the test force. The range of the time axis t corresponds to the predetermined measurement period of the present disclosure. The range of the time axis t is auto-scaled according to the time width from the start to the end of the test.

The start of the test is the time point when the user performs a start operation, and the end of the test is the time point when the user performs an end operation, or the time point when a preset test time has elapsed, the time point when the test force or the displacement of the test piece TP has reached a limit, or the like. The load level indicator image 104 indicates the reference point (zero point) of the test force at 104a and indicates the level of the current measured value of the test force with respect to the reference point 104a by the length of a bar 104b.

Further, the display controller 73 displays, as the change monitor image 100b, a change measurement label image 105 that clearly indicates that the display object is the displacement of the test piece TP, a change measurement value image 106 that shows the current (corresponding to the predetermined measurement time point of the present disclosure) measured value of the displacement of the test piece TP, a change measurement graph image 107 that shows the transition of the displacement of the test piece TP from the start of the test, and a change level indicator image 108 that shows the measurement level of the displacement of the test piece TP. In the change monitor image 100b, the change measurement value image 106, the change measurement graph image 107, and the change measurement label image 105 are displayed in the lower half area (second area) of the test monitor screen 100 in a positional relationship where their respective correspondences can be recognized.

The change measurement graph image 107 shows the transition of the displacement from the start of the test, with the vertical axis set to the level of the displacement of the test piece TP and the horizontal axis set to the same time t as the load measurement graph image 103, and shows a reference point (zero point) 107a of the displacement, a positive-side limit 107b of the displacement, and a negative-side limit 107c of the displacement. The range of the time axis t corresponds to the predetermined measurement period of the present disclosure. The change level indicator image 108 indicates the reference point (zero point) of the displacement at 108a and indicates the level of the current measured value of the displacement with respect to the reference point by the length of a bar 108b.

The load measurement graph image 103 and the change measurement graph image 107 are arranged in the vertical direction of the test monitor screen 100, whereby the user (test operator) of the high-speed tensile testing machine 1 can easily grasp the transition of the test force applied to the test piece TP and the displacement of the test piece TP while comparing them on the same time axis t.

Furthermore, by intentionally not displaying numerical values or symbols on the vertical and horizontal axes of the graph for the load measurement graph image 103 and the change measurement graph image 107, only the transition of the test force and the displacement of the test piece TP can be easily visualized.

Note that the load measurement value image 102 may be displayed superimposed on the load measurement graph image 103. Similarly, the change measurement value image 106 may be displayed superimposed on the change measurement graph image 107.

In the subsequent step S3, the display controller 73 determines whether or not measurement data M(t) has been received from the control device 5. When the measurement data M(t) has been received, the process proceeds to step S10, and when the measurement data M(t) has not been received, the process proceeds to step S4. In step S10, the load measurement unit 71 measures the test force applied to the test piece TP based on the digital conversion value of the force detection signal Db included in the measurement data M(t). In the subsequent step S11, the change measurement unit 72 measures the displacement of the test piece TP based on the digital conversion value of the displacement detection signal Dc included in the measurement data M(t).

In the next step S12, the display controller 73 updates the load measurement value image 102, the load measurement graph image 103, the load level indicator image 104, the change measurement value image 106, the change measurement graph image 107, and the change level indicator image 108 to be displayed on the test monitor screen 100, based on the current test force measured by the load measurement unit 71 and the current displacement of the test piece TP measured by the change measurement unit 72, and then the process proceeds to step S4.

In step S4, the display controller 73 determines whether or not test end data indicating that the high-speed tensile test has ended has been received from the control device 5. Then, when the test end data has not been received, the display controller 73 proceeds to step S3 and executes the processing from step S3 onward again. On the other hand, when the test end data has been received, the display controller 73 proceeds to step S5 and ends the display control process.

### 3. Other Display Examples of Test Monitor Screen

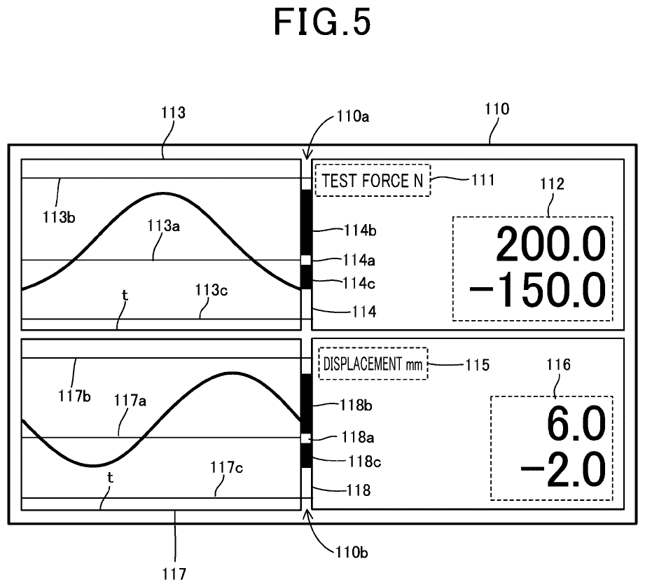

In FIG. 4, the test monitor screen 100 where the measurement period is from the start to the end of the high-speed tensile test has been exemplified. As another embodiment, when performing a test in which a test force of a predetermined load pattern is repeatedly applied to a test piece, as shown in FIG. 5, a test monitor screen 110 may be displayed on the display 61, where one cycle of the repetition of the load pattern is set as the display measurement period, and the display is updated every time one cycle of the load pattern elapses.

In the test monitor screen 110 shown in FIG. 5, the display controller 73 displays, as a load monitor image 110a, a load measurement label image 111, a load measurement value image 112, a load measurement graph image 113, and a load level indicator image 114. The load measurement value image 112 displays the positive-side peak value (200.0) and the negative-side peak value (−150.0) during the measurement period of the test force displayed on the load measurement graph image 113.

The load measurement graph image 113 shows a reference point (zero point) 113a of the test force, a positive-side limit 113b (alarm set value), and a negative-side limit 113c (alarm set value). The range of the time axis t corresponds to the predetermined measurement period of the present disclosure. Note that the average value or amplitude value of the load may be displayed on the load measurement graph image 113. The load level indicator image 114 indicates the reference point (zero point) of the test force at 114a, indicates the level of the positive-side peak of the test force by the length of a bar 114b, and indicates the level of the negative-side peak of the test force by the length of a bar 114c.

Further, the display controller 73 displays, as a change monitor image 110b, a change measurement label image 115, a change measurement value image 116, a change measurement graph image 117, and a change level indicator image 118. The change measurement value image 116 displays the positive-side peak value (6.0) and the negative-side peak value (−2.0) of the displacement of the test piece during the measurement period of the displacement of the test piece displayed on the change measurement graph image 117.

The change measurement graph image 117 shows a reference point (zero point) 117a of the displacement of the test piece, a positive-side limit 117b (alarm set value), and a negative-side limit 117c (alarm set value). The range of the time axis t corresponds to the predetermined measurement period of the present disclosure. Note that the average value or amplitude value of the displacement may be displayed on the change measurement graph image 117. The change level indicator image 118 indicates the reference point (zero point) of the displacement of the test piece at 118a, indicates the level of the positive-side peak of the displacement by the length of a bar 118b, and indicates the level of the negative-side peak of the displacement by the length of a bar 118c.

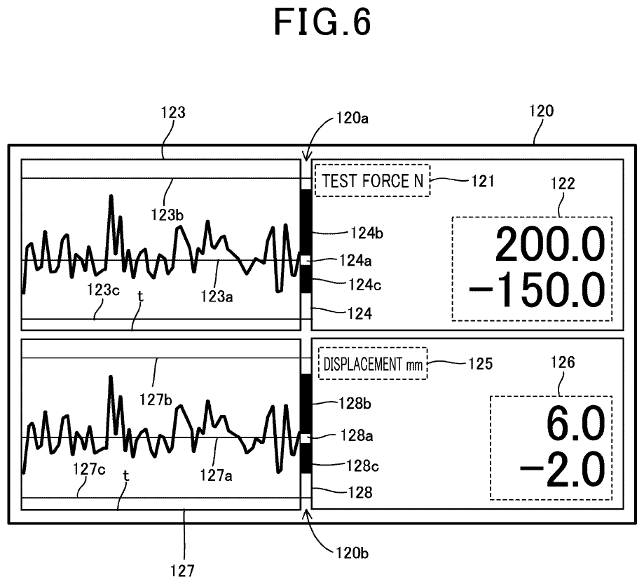

Furthermore, while FIG. 5 shows a case where a sinusoidal test force is repeatedly applied to the test piece, as shown in FIG. 6, not only simple sine waves or triangular waves but also a test monitor screen 120 that displays an actual service waveform for one cycle may be displayed on the display 61. The test monitor screen 120 shown in FIG. 6 includes, similar to the test monitor screen 110 shown in FIG. 5, a load monitor image 120a displayed in the upper half area of the test monitor screen 120 and a change monitor image 120b displayed in the lower half area of the test monitor screen 120.

The display controller 73 displays, as the load monitor image 120a, a load measurement label image 121, a load measurement value image 122, a load measurement graph image 123, and a load level indicator image 124, similar to the load monitor image 110a shown in FIG. 5. Further, the display controller 73 displays, as the change monitor image 120b, a change measurement label image 125, a change measurement value image 126, a change measurement graph image 127, and a change level indicator image 128, similar to the change monitor image 110b shown in FIG. 5.

### 4. Other Embodiments

In the above embodiment, as shown in FIG. 4, the display controller 73 arranged and displayed the load measurement graph image 103 and the change measurement graph image 107 in the vertical direction of the test monitor screen 100 with a common time axis. As another embodiment, the load measurement graph image 103 and the change measurement graph image 107 may be arranged and displayed in another direction, such as the horizontal direction of the test monitor screen 100.

In the above embodiment, as shown in FIG. 4, the display controller 73 arranged and displayed the load measurement value image 102 and the load measurement graph image 103 in the horizontal direction of the test monitor screen 100, but the load measurement value image 102 and the load measurement graph image 103 may be arranged and displayed in another direction, such as the vertical direction of the test monitor screen 100. The same applies to the change measurement value image 106 and the change measurement graph image 107.

In the above embodiment, as shown in FIG. 4, the display controller 73 displayed the load level indicator image 104 between the load measurement value image 102 and the load measurement graph image 103. As another embodiment, the display of the load level indicator image 104 may be omitted.

In the above embodiment, as shown in FIG. 4, the display controller 73 displayed the change level indicator image 108 between the change measurement value image 106 and the change measurement graph image 107. As another embodiment, the display of the change level indicator image 108 may be omitted.

In the above embodiment, as shown in FIG. 4, for the load measurement graph image 103 and the change measurement graph image 107, the visibility of the transition of the test force and the displacement of the test piece was facilitated by intentionally not displaying numerical values or symbols on the vertical and horizontal axes of the graph. As another embodiment, numerical values and symbols may be displayed on the vertical and horizontal axes of the graph, or the display and non-display of numerical values and symbols may be switchable by a user's selection operation.

In the above embodiment, the high-speed tensile testing machine 1 was shown as a test apparatus that executes a predetermined test of the present disclosure, but the test apparatus of the present disclosure may be any test apparatus that executes a predetermined test for applying some kind of load to a test piece and measuring the change of the test piece in response to the application of the load. The load applied to the test piece may be heating, cooling, etc., in addition to a force (tension, bending, compression, shear, etc.).

### 5. Aspects

It will be understood by those skilled in the art that the plurality of exemplary embodiments described above are specific examples of the following aspects.
(Item 1) A test apparatus comprising: a test load applying unit that applies a test load to a test piece; a load measurement unit that measures a load acting on the test piece; a change measurement unit that measures a change occurring in the test piece; a controller that controls an operation of the test load applying unit; a display unit; and a display controller that causes the display unit to display a test monitor screen including a load monitor image that displays a measurement history of the load by the load measurement unit and a change monitor image that shows a measurement history of the change by the change measurement unit, wherein the display controller displays, as the load monitor image, a load measurement value image indicating a measured value of the load measured by the load measurement unit at a predetermined measurement time point, a load measurement graph image showing a time-series transition of the load measured by the load measurement unit during a predetermined measurement period including the predetermined measurement time point, and a load measurement label image indicating that it is a measurement result of the load, in a first area of the test monitor screen, and displays, as the change monitor image, a change measurement value image indicating a measured value of the change measured by the change measurement unit at the predetermined measurement time point, a change measurement graph image showing a time-series transition of the change measured by the change measurement unit during the predetermined measurement period, and a change measurement label image indicating that it is a measurement result of the change, in a second area of the test monitor screen different from the first area.

According to the test apparatus of Item 1, at a predetermined measurement time point, a test monitor screen is displayed on the display unit, the screen including a load monitor image showing the measurement result of the load applied to the test piece and a change monitor image showing the measurement result of the change occurring in the test piece. Then, as the load monitor image, a load measurement label image that clearly indicates that the display object is the load, a load measurement value image, and a load measurement graph are displayed in the first area, and as the change monitor image, a change measurement label image that clearly indicates that the display object is the change in the test piece, a change measurement value image, and a change measurement graph are displayed in the second area.

This makes it possible to display the measurement history of the load applied to the test piece and the change in the test piece according to the load, including the current value and the status of the time-series transition, on a single display in a manner that is easily graspable by the user.
(Item 2) The test apparatus according to Item 1, wherein the display controller displays, as the load monitor image, the load measurement value image, the load measurement graph image, and the load measurement label image in a positional relationship where their respective correspondences can be recognized in the first area of the test monitor screen, and displays, as the change monitor image, the change measurement value image, the change measurement graph image, and the change measurement label image in a positional relationship where their respective correspondences can be recognized in the second area of the test monitor screen.

According to the test apparatus of Item 2, it is possible to make it easier for the user to grasp that the load measurement value image, the load measurement graph image, and the load measurement label image in the load monitor image are corresponding images, and that the change measurement value image, the change measurement graph image, and the change measurement label image in the change monitor image are corresponding images.
(Item 3) The test apparatus according to Item 1 or 2, wherein the display controller arranges and displays the load measurement graph image and the change measurement graph image in a vertical direction of the test monitor screen.

According to the test apparatus of Item 3, by arranging and displaying the load measurement graph image and the change measurement graph for the same predetermined measurement period in the vertical direction of the test monitor screen, it is possible to make it easier to grasp the followability of the transition of the load applied to the test piece and the change in the test piece.
(Item 4) The test apparatus according to any one of Items 1 to 3, wherein the display controller arranges and displays the load measurement value image and the load measurement graph image in a horizontal direction of the test monitor screen.

According to the test apparatus of Item 4, by arranging and displaying the load measurement value image and the load measurement graph image in the horizontal direction of the test monitor screen, it is possible to make it easier for the user to confirm both the transition of the load and the current value of the load.
(Item 5) The test apparatus according to Item 4, wherein the display controller displays a load level indicator image, which indicates a level of the load measured by the load measurement unit at the predetermined measurement time point by a vertical bar indicator on the test monitor screen, between the load measurement value image and the load measurement graph image.

According to the test apparatus of Item 5, while indicating the increase and decrease of the load in real time with good visibility by the load level indicator image, it is possible to make it easier to confirm both the current value of the load and the transition of the load by the load measurement value image and the load measurement graph image arranged on the left and right of the load level indicator image.
(Item 6) The test apparatus according to any one of Items 1 to 5, wherein the display controller arranges and displays the change measurement value image and the change measurement graph image in a horizontal direction of the test monitor screen.

According to the test apparatus of Item 6, by arranging and displaying the change measurement value image and the change measurement graph image in the horizontal direction of the test monitor screen, it is possible to make it easier for the user to confirm both the transition of the change of the test piece and the current value of the change.
(Item 7) The test apparatus according to Item 6, wherein the display controller displays a change level indicator image, which indicates a level of the change measured by the change measurement unit at the predetermined measurement time point by a vertical bar indicator on the test monitor screen, between the change measurement value image and the change measurement graph image.

According to the test apparatus of Item 7, while indicating the increase and decrease of the change of the test piece in real time with good visibility by the change level indicator image, it is possible to make it easier to confirm both the current value of the change of the test piece and the transition of the change by the change measurement value image and the change measurement graph image arranged on the left and right of the change level indicator image.
(Item 8) The test apparatus according to any one of Items 1 to 7, wherein the display controller updates the change measurement graph image every time one cycle of the load pattern elapses when the test load applying unit is repeatedly applying a predetermined load pattern to the test load under the control of the controller.

According to the test apparatus of Item 8, it is possible to display the status of the change in the test piece corresponding to the change for one cycle of the load pattern by the change measurement graph image.
(Item 9) A display control method executed by a computer when a predetermined test is being performed in a test apparatus having a test load applying unit that applies a test load to a test piece and a test execution unit that controls an operation of the test load applying unit to execute the predetermined test, the method comprising: a load measurement step of measuring a load acting on the test piece; a change measurement step of measuring a change occurring in the test piece; and a display control step of causing a display unit to display a test monitor screen including a load monitor image that displays a measurement history of the load by the load measurement step and a change monitor image that shows a measurement history of the change by the change measurement step, wherein the display control step displays, as the load monitor image, a load measurement value image indicating a measured value of the load measured by the load measurement step at a predetermined measurement time point, a load measurement graph image showing a time-series transition of the load measured by the load measurement step during a predetermined measurement period including the predetermined measurement time point, and a load measurement label image indicating that it is a measurement result of the load, in a first area of the test monitor screen, and displays, as the change monitor image, a change measurement value image indicating a measured value of the change measured by the change measurement step at the predetermined measurement time point, a change measurement graph image showing a time-series transition of the change measured by the change measurement step during the predetermined measurement period, and a change label image indicating that it is a measurement result of the change, in a second area of the test monitor screen different from the first area.

By executing the display control method of Item 9 by a computer, it is possible to obtain the same operational effects as the test apparatus of Item 1.
(Item 10) A non-transitory computer readable storage medium storing a program that, when a predetermined test is being performed in a test apparatus having a test load applying unit that applies a test load to a test piece and a test execution unit that controls an operation of the test load applying unit to execute the predetermined test, causes a computer to function as: a load measurement unit that measures a load acting on the test piece; a change measurement unit that measures a change occurring in the test piece; and a display controller that causes a display unit to display a test monitor screen including a load monitor image that displays a measurement history of the load by the load measurement unit and a change monitor image that shows a measurement history of the change by the change measurement unit, wherein the display controller displays, as the load monitor image, a load measurement value image indicating a measured value of the load measured by the load measurement unit at a predetermined measurement time point, a load measurement graph image showing a time-series transition of the load measured by the load measurement unit during a predetermined measurement period including the predetermined measurement time point, and a load measurement label image indicating that it is a measurement result of the load, in a first area of the test monitor screen, and displays, as the change monitor image, a change measurement value image indicating a measured value of the change measured by the change measurement unit at the predetermined measurement time point, a change measurement graph image showing a time-series transition of the change measured by the change measurement unit during the predetermined measurement period, and a change label image indicating that it is a measurement result of the change, in a second area of the test monitor screen different from the first area.

By executing the storage medium of Item 10 by a computer, it is possible to realize the configuration of the test apparatus of Item 1.

### REFERENCE SIGNS LIST

1 High-speed tensile testing machine (Test apparatus)
2 Testing machine main body
5 Control device
6 Processing device
20a Upper chuck
20b Lower chuck
27 Load cell
30 Hydraulic cylinder (Load mechanism)
32 Stroke sensor
40 Extensometer
51 Servo drive unit
52 Test execution unit
53 Detection signal acquisition unit
61 Display
70 Processor
71 Load measurement unit
72 Change measurement unit
73 Display controller
80 Memory
81 Program
100 Test monitor screen
100a Load monitor image
101 Load measurement label image
102 Load measurement value image
103 Load measurement graph image
104 Load level indicator image
105 Change measurement label image
106 Change measurement value image
107 Change measurement graph image
108 Change level indicator image
TP Test piece

1. A test apparatus, comprising:
a test load applying unit configured to apply a test load to a test piece;
a load measurement unit configured to measure a load acting on the test piece;
a change measurement unit configured to measure a change occurring in the test piece;
a controller configured to control an operation of the test load applying unit;
a display unit; and
a display controller configured to cause the display unit to display a test monitor screen including a load monitor image that displays a measurement history of the load by the load measurement unit, and a change monitor image that shows a measurement history of the change by the change measurement unit,
wherein the display controller is configured to:
display, as the load monitor image, a load measurement value image indicating a measured value of the load measured by the load measurement unit at a predetermined measurement time point, a load measurement graph image showing a time-series transition of the load measured by the load measurement unit during a predetermined measurement period including the predetermined measurement time point, and a load measurement label image indicating that it is a measurement result of the load, in a first area of the test monitor screen, and
display, as the change monitor image, a change measurement value image indicating a measured value of the change measured by the change measurement unit at the predetermined measurement time point, a change measurement graph image showing a time-series transition of the change measured by the change measurement unit during the predetermined measurement period, and a change measurement label image indicating that it is a measurement result of the change, in a second area of the test monitor screen different from the first area.

2. The test apparatus according to claim 1, wherein the display controller is configured to:
display, as the load monitor image, the load measurement value image, the load measurement graph image, and the load measurement label image in a positional relationship where their respective correspondences can be recognized in the first area of the test monitor screen, and
display, as the change monitor image, the change measurement value image, the change measurement graph image, and the change measurement label image in a positional relationship where their respective correspondences can be recognized in the second area of the test monitor screen.

3. The test apparatus according to claim 1, wherein the display controller is configured to arrange and display the load measurement graph image and the change measurement graph image in a vertical direction of the test monitor screen.

4. The test apparatus according to claim 1, wherein the display controller is configured to arrange and display the load measurement value image and the load measurement graph image in a horizontal direction of the test monitor screen.

5. The test apparatus according to claim 4, wherein the display controller is configured to display a load level indicator image, which indicates a level of the load measured by the load measurement unit at the predetermined measurement time point by a vertical bar indicator on the test monitor screen, between the load measurement value image and the load measurement graph image.

6. The test apparatus according to claim 1, wherein the display controller is configured to arrange and display the change measurement value image and the change measurement graph image in a horizontal direction of the test monitor screen.

7. The test apparatus according to claim 6, wherein the display controller is configured to display a change level indicator image, which indicates a level of the change measured by the change measurement unit at the predetermined measurement time point by a vertical bar indicator on the test monitor screen, between the change measurement value image and the change measurement graph image.

8. The test apparatus according to claim 1, wherein the display controller is configured to update the change measurement graph image every time one cycle of a load pattern elapses when the test load applying unit is repeatedly applying the predetermined load pattern to the test piece under control of the controller.

9. A display control method executed by a computer in a test apparatus having a test load applying unit that applies a test load to a test piece and a test execution unit that controls an operation of the test load applying unit to execute a predetermined test, the predetermined test being performed, the method comprising:
a load measurement step of measuring a load acting on the test piece;
a change measurement step of measuring a change occurring in the test piece; and
a display control step of causing a display unit to display a test monitor screen including a load monitor image that displays a measurement history of the load by the load measurement step, and a change monitor image that shows a measurement history of the change by the change measurement step,
wherein the display control step includes:
displaying, as the load monitor image, a load measurement value image indicating a measured value of the load measured by the load measurement step at a predetermined measurement time point, a load measurement graph image showing a time-series transition of the load measured by the load measurement step during a predetermined measurement period including the predetermined measurement time point, and a load measurement label image indicating that it is a measurement result of the load, in a first area of the test monitor screen, and
displaying, as the change monitor image, a change measurement value image indicating a measured value of the change measured by the change measurement step at the predetermined measurement time point, a change measurement graph image showing a time-series transition of the change measured by the change measurement step during the predetermined measurement period, and a change measurement label image indicating that it is a measurement result of the change, in a second area of the test monitor screen different from the first area.

10. A non-transitory computer readable storage medium storing a program that, when a predetermined test is being performed in a test apparatus having a test load applying unit that applies a test load to a test piece and a test execution unit that controls an operation of the test load applying unit to execute the predetermined test, causes a computer to function as:
a load measurement unit configured to measure a load acting on the test piece;
a change measurement unit configured to measure a change occurring in the test piece; and
a display controller configured to cause a display unit to display a test monitor screen including a load monitor image that displays a measurement history of the load by the load measurement unit, and a change monitor image that shows a measurement history of the change by the change measurement unit,
wherein the display controller is configured to:
display, as the load monitor image, a load measurement value image indicating a measured value of the load measured by the load measurement unit at a predetermined measurement time point, a load measurement graph image showing a time-series transition of the load measured by the load measurement unit during a predetermined measurement period including the predetermined measurement time point, and a load measurement label image indicating that it is a measurement result of the load, in a first area of the test monitor screen, and
display, as the change monitor image, a change measurement value image indicating a measured value of the change measured by the change measurement unit at the predetermined measurement time point, a change measurement graph image showing a time-series transition of the change measured by the change measurement unit during the predetermined measurement period, and a change measurement label image indicating that it is a measurement result of the change, in a second area of the test monitor screen different from the first area.
